(19) United States
(12) Patent Application Publication
(10) Pub. No.: US 2010/0327835 A1
(43) Pub. Date: Dec. 30, 2010

(54) INTEGRATOR FOR PROVIDING OVERSHOOT PROTECTION AND LIGHT SWITCHING MODE DURING NON-ZERO LOAD CONDITION FOR AN LED DRIVER CIRCUITRY

(75) Inventor: NICHOLAS IAN ARCHIBALD, SAN FRANCISCO, CA (US)

Correspondence Address: HOWISON & ARNOTT, L.L.P, P.O. BOX 741715, DALLAS, TX, 75374-1715, US

(73) Assignee: INTERSIL AMERICAS INC., MILPITAS, CA (US)

(21) Appl. No.: 12/730,960

(22) Filed: Mar. 24, 2010

Related U.S. Application Data
(63) Continuation-in-part of application No. 12/492,748, filed on Jun. 26, 2009.
(60) Provisional application No. 61/246,433, filed on Sep. 28, 2009.

(51) Int. Cl. G05F 1/10

(52) U.S. Cl. 323/282

(57) ABSTRACT

A voltage regulator system comprises circuitry for generating a regulated output voltage responsive to an input voltage and switching control signals. A voltage divider is connected to an output node of the circuitry to provide a way to monitor the output voltage. A voltage regulator controller generates the switching control signals responsive to the monitored output voltage and a reference voltage. A compensation network is associated with the voltage regulator controller. The voltage regulator controller further controls the circuitry for regulating an output current pulse for the regulated output voltage responsive to an indication that the monitored output voltage is below a reference voltage in the no-load condition without interaction with the loop compensation network. The voltage regulator controller further selectively associates the compensation network with the voltage regulator controller responsive to a load condition and selectively disconnects the compensation network from the voltage regulator controller responsive to a no-load condition.

### CROSS-REFERENCE TO RELATED APPLICATIONS

This application is a continuation-in-part of U.S. patent application Ser. No. 12/492,748, filed Jun. 26, 2009, entitled DYNAMIC HEADROOM CONTROL FOR LCD DRIVER, and this application claims priority to U.S. Provisional Patent Application No. 61/246,433, filed Sep. 28, 2009, entitled INTEGRATION FOR PROVIDING OVERSHOOT PROTECTION AND LIGHT SWITCHING MODE DURING NON-ZERO LOAD CONDITIONS FOR AN LED DRIVER CIRCUIT, both of which are incorporated herein by reference.

### BRIEF DESCRIPTION OF THE DRAWINGS

For a more complete understanding, reference is now made to the following description taken in conjunction with the accompanying Drawings in which:

FIG. 1 is a block diagram of an LED driver circuit;

FIG. 2 illustrates is a simplified block diagram more fully illustrating circuitry for implementing dynamic headroom control within an LED driver circuit;

FIG. 3 is a flow diagram describing the operation of the circuit of FIG. 2;

FIG. 4 is a simplified block diagram more fully describing the manner for transient suppression within the boost converter of the LED driver;

FIG. 5 illustrates the boost transients created by changes in the load at the output of the LED driver;

FIG. 6 is a flow diagram describing the operation of the circuitry for suppressing the boost transients;

FIG. 7 illustrates the manner in which the circuitry of FIG. 4 suppresses the boost transients responsive to a change in the inductor load current;

FIG. 8 is a simplified block diagram illustrating the manner for providing boost ripple rejection within the LED driver;

FIGS. 9a and 9b disclose wave forms illustrating operation of the circuit of FIG. 8 both with and without the use of sample and hold circuitry;

FIG. 10 is a simplified schematic block diagram of a boost regulator including an integrator;

FIG. 11 is a schematic diagram of the GM amplifier of FIG. 10;

FIG. 12 is a flow diagram describing the operation of the GM amplifier when providing overshoot protection and during the light switching mode of operation during a non-zero load condition;

FIG. 13 illustrates various waveforms associated with the operation of the boost regulator of FIG. 10 with respect to the inductor current, load current, GM amplifier output and output voltage; and

FIG. 14 further illustrates waveforms associated with the operation of the boost regulator of FIG. 10 with respect to inductor current, output voltage and voltage at the bottom of an LED stack during operation in a light switching mode of operation.

### DETAILED DESCRIPTION

Referring now to the drawings, wherein like reference numbers are used herein to designate like elements throughout, the various views and embodiments of an GM amplifier for providing overshoot protection and light switching mode during non-zero load condition for an led driver circuit are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

LED drivers are used for driving LEDs in various applications. Multi channel LED drivers may be used for driving multiple strings (i.e., channels) of LEDs for use in various applications such as backlighting. Existing LED drivers may have problems providing sufficient headroom for the LED strings and may also experience excessive transients within the output of switching converters within the LED driver due to changes in load currents.

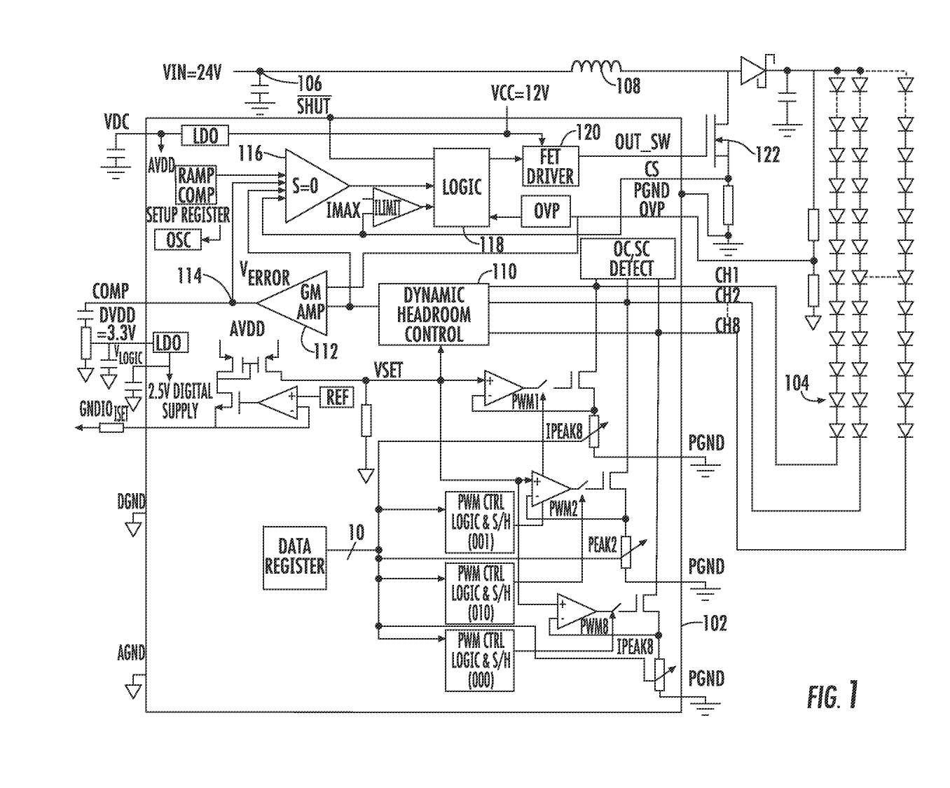

Referring now to the drawings, and more particularly to FIG. 1, there is illustrated a block diagram of one embodiment of an LED driver 102. The LED driver 102 is connected to drive multiple LED strings 104. The driver 102 of FIG. 1 controls eight channels of LED current to enable the LED strings 104 to be used for LCD backlight applications. The drive voltage for the LED strings is regulated from an input voltage node 106 by switching the current in an inductor 108. The drive voltage is provided to the top of each LED string 104. Voltages at the bottom of each LED string 104 are monitored by Dynamic Headroom Control block 110 to determine the voltage at the bottom of each string. Amplifier 112 generates a COMP voltage at node 114 responsive to voltage information from the feedback stack connected to the pot-down from the drive voltage fed into the OVP (over voltage protection) block. The COMP voltage from node 114 along with other information are input to a summation circuit 116 that provides a control output to control logic 118 for controlling the FET driver circuitry 120 controlling the operation of a switching transistor 122 which in turn regulates LED drive voltage by controlling the current in the inductor 108.

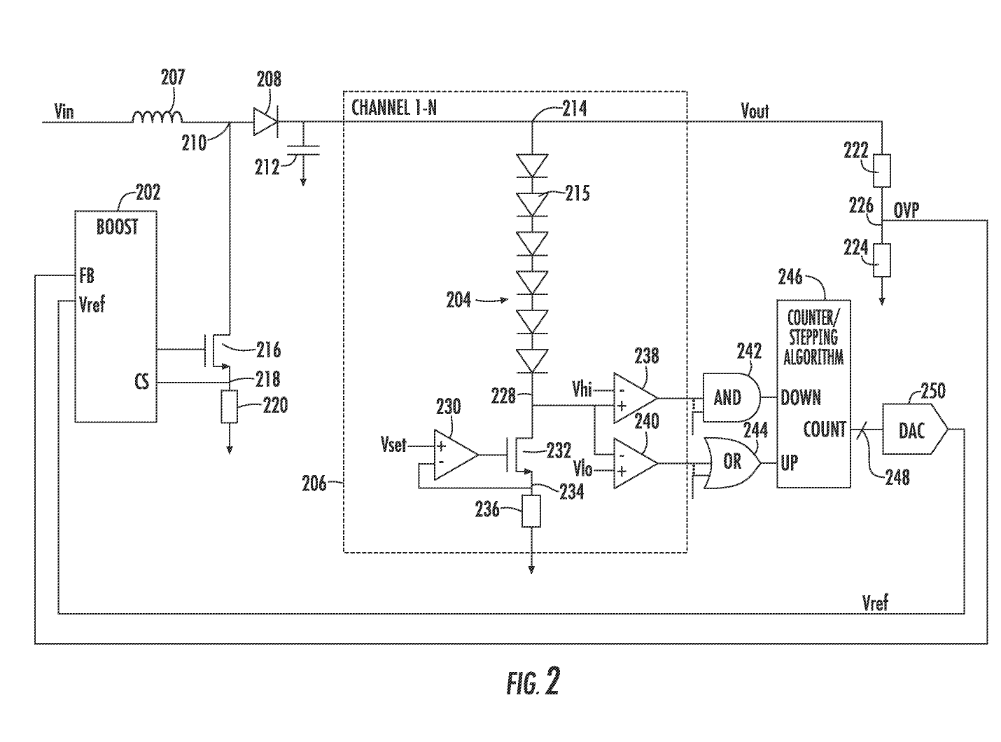

Referring now to FIG. 2, there is illustrated a simplified block diagram of the circuitry used for providing dynamic headroom control within the LED driver 102. Within the LED driver 102, multiple channels of LED strings 204 are operated using a boost controller 202 and a boost converter (including components 202, 207, 208, 212, 216, 218, and 220) to generate a voltage that is applied to the top of several stacks of series LED strings 204 which are each connected in parallel to a separate current source at the bottom end of the LED string 204. While the illustration in FIG. 2 only presents a single LED string 204 connected with the boost converter, in operation multiple LED strings 204 are connected with the boost converter such that multiple iterations of the circuit block 206 would exist, one for each LED string. The input voltage V_{IN} is applied to a first side of an inductor 207. The other side of the inductor 207 is connected to an anode of diode 208 at node 210. A capacitor 212 is connected between the cathode of diode 208 and ground. The cathode of diode 208 is connected to the top of the LED string 204 at node 214. A switching transistor 216 has its drain/source path connected between node 210 and node 218. The gate of transistor 216 receives drive signals from the boost controller 202. Node 218 is connected to the current sense (CS) input of the boost controller 202. A resistor 220 is connected between node 218 and ground.

The top of the LED string at node 214 comprises an output voltage node V_{OUT} which is connected to a resistor divider consisting of resistors 222 and 224. Resistor 222 is connected between node 214 and node 226. Resistor 224 is connected between node 226 and ground. A voltage measurement is taken at node 226 (from the pin usually used for over voltage protection purposes) and provided to the boost regulator 202 as a feedback voltage V_{FB}. The LED string 204 consists of a plurality of individual LEDs 215 which are connected in series between node 214 and node 228. A current source is provided at the bottom of the LED string at node 228. The current source consists of an amplifier 230 connected to receive a reference voltage VSET at the non-inverting input. The voltage VSET is used to set the current. The output of the amplifier 230 is connected to a transistor 232 having its drain/source path connected between node 228 and node 234. The other input of amplifier 230 is connected to node 234. The inverting input of amplifier 230 is connected to node 234. A resistor 236 is connected between node 234 and ground. The disclosed embodiment comprises one example of the current source. However, other implementations of the current source may be used.

The voltage generated at node 228 is applied to the non-inverting input of comparators 238 and inverting input of comparator 240. The inverting input of comparator 238 is connected to receive a reference voltage V_{HIGH}. The non-inverting input of comparator 240 is connected to receive a reference voltage V_{LOW}. The output of comparator 238 is connected to one input of an AND gate 242. The remaining inputs of AND gate 242 would be connected to the outputs of the comparator 238 from each of the other channels associated with each of the other circuit blocks 206. Similarly, the output of comparator 240 is connected to one input of an OR gate 244. The remaining inputs of OR gate 244 would be connected to the outputs of the comparators in each of the other channels from circuit block 206. The output of AND gate 242 is provided to the DOWN input of counter/stepping algorithm 246. The output of OR gate 244 is connected to the UP input of the counter/stepping algorithm 246. The counting/stepping algorithm 246 generates a count value via bus 248 that is input to a digital-to-analog converter 250. The digital-to-analog converter 250 generates an output analog value that is used as the reference voltage V_{REF} that is applied back to the boost regulator circuitry 202.

The multi-channel LED configuration using a boost/buck switching regulator generates a single voltage at node 214 to drive the top of a plurality of series LED strings 204. Each of the series stacks of LED strings 204 are connected in parallel to a separate current source at the bottom node 228. This allows a savings in circuit hardware by sharing the switching regulator between multiple LED strings 204. This configuration drives a large number of LEDs without requiring excessively high voltages. However, the voltages must be carefully regulated to eliminate power dissipation in the current sources which will cause thermal problems and limit overall circuit efficiency. As the voltage of the LEDs are variable (with process, temperature and aging effects), previous implementations of these systems have used the voltage at the output of the current sources at node 228 as a feedback point for the regulator allowing the regulator to be adaptive and move the optimum operating level. This minimizes power dissipation due to the voltage drop across the current source. Typically this is done by passing the analog voltages at the bottom of each LED string 204 to a control block which picks out the lowest voltage level from each of the LED strings and passes this selected voltage on as the feedback voltage. This feedback voltage is regulated to a level which has been defined such that the current sources will have sufficient headroom not to be pushed in a linear region of operation (typically several hundred millivolts). This works well when all LED strings are running with the same pulse width modulated (PWM) dimming signal, as whenever any string is conducting, all strings are conducting. This means that real time information is available on which string has the lowest voltage at all times when the boost voltage regulator 202 is switching.

However, for systems where different PWM dimming signals are used for different channels, it is possible for there to be no time when all channels are conducting at once. It would be possible to regulate on the basis of only those channels that are conducting at a given point in time, resulting in a switching regulator output voltage level which varies as different channels turn on and off. However, this solution provides a poor output voltage transient response resulting in short current pulses being noticeably compressed in situations where there is a mismatch between strings.

If, for example, all LED strings 204 have the same conducting voltage, except for one which needs one volt more, and the LED string is only turned on for a 490 nanosecond pulse every 500 microseconds (as would be the case with the lowest dimming signal in a 10-bit PWM dimming scheme running on a 2 KHz PWM frequency), the boost regulator 202 would have to respond in substantially less than this time. It is not practical to build the boost regulator 202 for such an application that has a transient response that is dynamically faster than 490 nanoseconds. In practice, the response time will be a period of tens to hundreds of microseconds, which is far too slow. This means that the boost regulator 202 will miss the 490 nanosecond period when the circuit requires extra head room, which in turn is likely to mean that the current source has insufficient headroom and that the 490 nanosecond current pulse will not reach its intended peak current. This compression of current will cause a corresponding reduction of the brightness of the LED string, for the lower PWM duty cycles and strings with higher forward voltages than other strings in the system. The implementation described with respect to FIG. 2 uses a different approach to determine the switching regulator output voltage provided by the boost voltage regulator 202.

The voltage window between the reference voltages V_{HIGH} and V_{LOW} is set to be larger than the smallest single step that can be introduced onto the boost regulator output voltage node 214 by the control scheme, guaranteeing that at least one output level will obtain a stable operating point. The voltage control is achieved by regulating the output voltage of the boost regulator 202 to a reference voltage input V_{REF} that is generated from the digital-to-analog converter (DAC) 250. The counter/stepping algorithm 246 controls the reference voltage provided by the DAC 250 to cause the voltage at the bottom of a lowest voltage node of the plurality of LED strings 204 to remain between the high reference voltage and the low reference voltage The DAC 250 output can be moved up and down to the required level by digital control signals provided from the counter/stepping algorithm 246 to the required level by a digital control scheme based upon information gained from monitoring the channel voltages at the bottom of each LED string 204. The OVP signal monitored at node 226 is used as the feedback signal for the boost regulator 202, which is regulated to the voltage level dictated by the reference voltage provided from the DAC 250. This provides the correct voltage for the LED string 204 with the highest forward voltage requirement no matter how short the time a particular LED string is conducting. Additionally, stability is improved over systems which take the boost feedback from the bottom of the LED strings, as the phase shift that would normally be introduced into the feedback path due to the interaction with the current source transient response and LED characteristics is eliminated from the control loop.

The DAC 250 is configured such that successive changes get larger and larger (up to a maximum step size limit) in order to reach a target point, unless the output remains constant for longer than a certain time or changes direction. Any subsequent changes will be small to allow for minor fluctuations in the level required for temperature variations in the forward voltage of the LEDs, and those caused by noise in the system. The control algorithm is optimized to enable the output voltage to fall faster than it can rise as if the output voltage is too high, it can quickly cause thermal problems for the LED driver.

The LED driver monitors the switching regulator output voltage at node 226 to prevent the reference voltage V_{REF} from being changed if the boost regulator has not caught up with the target reference value and generates an output voltage responsive to the reference voltage. This prevents the reference voltage from “running away” from the required value and taking a long time to come back in line once the boost regulator 202 has caught up. This is particularly important when the boost regulator 202 output voltage is dropping. This is due to the fact that the boost regulator 202 can produce a very fast rise in the output voltage, but the only way to reduce the output voltage is to allow the current source to discharge the output capacitor during its normal conduction time. This can take a significant amount of time to lower the output voltage if the LED duty cycles are very low. Thus, the system will not allow the reference voltage to be changed upwards if the feedback of the output level is significantly below the current reference voltage and will not allow the reference voltage to be changed downwards if the feedback of the output level is significantly above the current reference voltage. The configuration also provides over voltage protection without requiring additional circuitry as there is a maximum DAC code above which the boost regulator 202 will not go. This level can be modified by changing the pot down ratio to the pin.

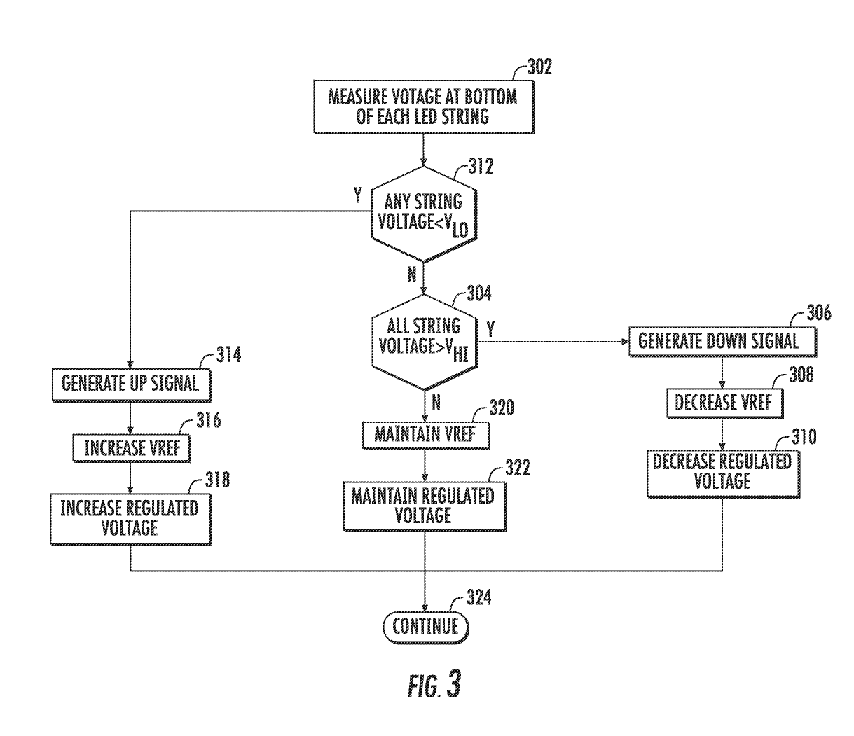

Referring now to FIG. 3, there is illustrated a flow diagram describing the operation of the circuit of FIG. 2. Voltage information is measured at step 302 at the bottom of each LED string 204 at node 228. This information is not fed to the boost regulator 202 in real time as feedback to the FB pin. Instead, the output voltage at node 214 is monitored through the voltage divider circuit consisting of resistors 222 and 224. The feedback voltage to the FB pin is provided from node 226 of the resistor divider. A voltage window is created between the reference voltages V_{HIGH} and V_{LOW} using comparators 238 and 240. Using these two comparators 238 and 240, the circuit attempts to regulate the lowest channel voltage on an LED string during conduction of the LED string. If inquiry step 312 determines if at least one of the voltages at node 228 is below a reference voltage V_{LOW} during conduction, this causes the associated comparator 240 on that channel to go to a logical “high” level which drives the output of OR gate 244 to a logical “high” level generating an UP signal at step 314. The logical “high” signal at the output of OR gate 244 causes the counter/stepping algorithm 246 and DAC 250 to increase the reference voltage V_{REF} at step 316. The increased reference voltage V_{REF} causes a corresponding increase at step 318 of the regulated voltage provided by the boost regulator 202.

If inquiry step 312 determines that none of the voltages at node 228 of the LED strings fall below the referenced voltage V_{LOW}, inquiry step 304 determines whether during the entire PWM period all channels associated with each LED string 204, except those channels which are completely turned off (i.e., 0% PWMs/disabled), were conducting at least once and whether all channels had a voltage at the bottom of its LED string that was above V_{HIGH} during conduction. If so, the regulated voltage is reduced by the counter/stepping algorithm 246. In this circumstance, the output of the comparator 238 would be at a logical “high” level for each LED string being driven by the LED driver, and these signals would drive the output of the AND gate 242 to a logical “high” level generating the DOWN signal at step 306. Responsive to the DOWN signal, the reference voltage V_{REF} is decreased by the counter/stepping algorithm 246 and DAC 250 at step 308. The reduced reference voltage provided by the DAC 250 will cause a corresponding decrease in the regulated voltage provided at node 214 by the boost regulator 202 at step 310.

If inquiry step 304 determines that all channel voltages at node 228 are not above the reference voltage V_{HIGH} for the entire PWM period, at least one of the voltages at nodes 228 is within the established voltage window, and the reference voltage is maintained at step 320. This causes the regulated voltage to be maintained at the established level at step 322. The process continues at step 324 and returns back to step 302 to continue monitoring the voltage at the bottom of each LED string at node 228.

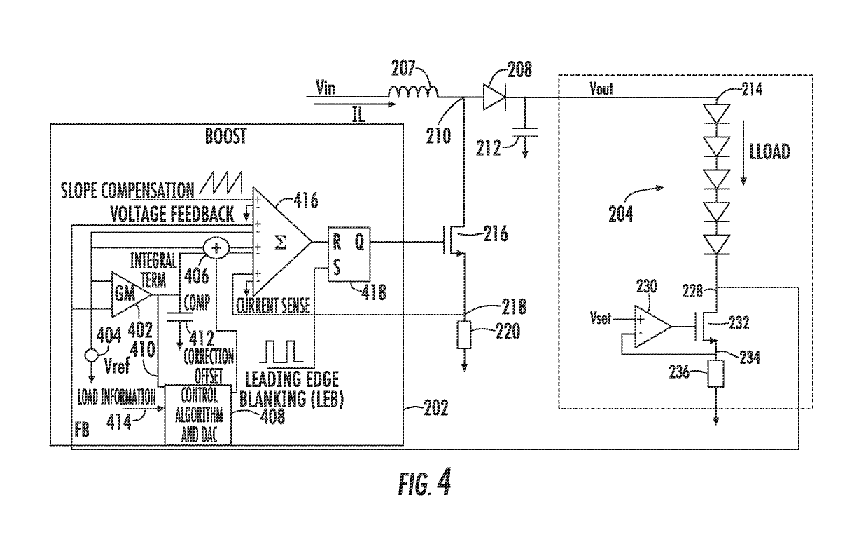

Referring now to FIG. 4, there is more particularly illustrated an alternative embodiment the circuitry within the boost regulator 202 for providing transient suppression within the output voltage V_{OUT} provided from node 210. The boost regulator 202 transients at known steps can be dramatically reduced by adding an offset to the COMP voltage V_{COMP} at the same time the load current IL through inductor 207 changes. The COMP voltage V_{COMP} is provided from the output of an GM amplifier 402, configured as an integrator. Addition of the offset to the output of the GM amplifier 402 saves the integrator formed around the GM amplifier 402 from having to settle to a new value, and the resulting over/under current delivered to the output during the settling time. This configuration however does not change the basic loop properties in each load condition. The GM amplifier 402 receives the feedback voltage FB from node 228, at the bottom of LED stack 204, although it can also be configured as in FIG. 2. Additionally, the GM amplifier 402 receives at a second input a reference voltage V_{REF} 404. The output of the GM amplifier 402 is connected to an adder circuit 406 and a control algorithm and DAC 408 through node 410. Also connected to node 410 is a capacitor 412 connected between node 410 and ground.

The control algorithm and DAC 408 generates a correction offset that is added with the COMP voltage provided from the output of the integrator configured GM amplifier 402 to dramatically reduce the boost transients as described herein above. The control algorithm and DAC 408 generates the correction offset responsive to the provided COMP voltage and provided load information provided from control input 414. The load information would comprise the load current through inductor 207. The COMP voltage including the correction offset is provided to the inputs of a summation circuit 416. Also provided as input to the summation circuit 416 are a slope compensation ramp signal, the feedback voltage V_{FB}, the reference voltage V_{REF}, the voltage monitored at node 218 at the source of switching transistor 216 and connections to system ground. The output of the summation circuit 416 is provided as a control output to the R input of a latch circuit 418. The latch circuit 418 also receives at its S input, a leading edge blanking signal (LEB). The leading edge blanking signal is a fixed frequency clock signal with a very low duty cycle (short “HIGH” time) which set the 418 flip flop. It can be used as a leading edge blanking signal, as well, if the flip flop 418 is set dominant. The flip-flop 418 generates at its Q output drive signals to the switching transistor 216.

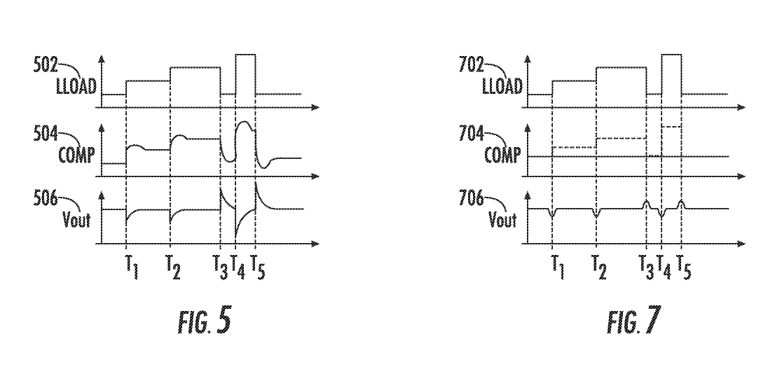

In a switching regulator 202, when a proportional control scheme is used, load regulation is very poor. Any increase in the load current through inductor 207 that is above the conduction point of the inductor 207 will result in a corresponding decrease in the output voltage V_{OUT}. However, while the response to a load step causes a change in the output voltage level, the time taken to settle to the new voltage level is very fast. In an integral system, extra gain at low frequencies is used to eliminate most of this load regulation characteristic. This is at the expense of a fast transient response, as the system can only respond to a transient with a bandwidth defined by the GM amplifier gm and loop filter (COMP) network impedance. This means that a step increase in the load current will cause an initial output voltage fall followed by a correction. Likewise, when a load is reduced in a step, the initial transient is in a positive direction. The larger the load current transient, the larger the corresponding output transient. These scenarios are more fully illustrated in FIG. 5.

Referring now to FIG. 5, there are illustrated the changes in the load current 502, the compensation voltage 504 and the output voltage 506 over a period of time. As can be seen, when there is a step increase in the load current 502 at times T₁, T₂ and T₄, a corresponding transient increase in the COMP voltage 504 occurs before the COMP voltage settles to a steady state level. Responsive to the COMP voltage 504, the output voltage V_{OUT} goes through a transient spike decrease, until the output voltage settles back to the regulated voltage level. Also, when there is a step decrease in the load current 502, the COMP voltage reacts with a corresponding decrease, and the regulated output voltage V_{OUT} 506 incurs a transient spike increase prior to settling back to the regulated voltage levels. These load transients can be dramatically reduced by adding the offset from the control algorithm and DAC 408 to the COMP voltage at adder 406 at the same time as the load changes as indicated by the load information provided at input 414. This saves the integrator, formed around the GM amplifier 402 from having to settle to a new feedback voltage level and the resulting over/under current delivery to the output during the settling time. The configuration has the added benefit of not changing the basic loop properties in each load condition.

There is a component in these transients illustrated in FIG. 5 that is caused by the time taken to ramp the inductor current I_{L} up or down to a new value that is difficult to correct for. However, this is not the dominant term. The implementation illustrated in FIG. 4 applies to systems where the load is known, and it is possible to correct for the remainder of the change. This is particularly relevant to a circuit including multi-string LED drivers where there are a known set of discrete possible loads. Any load regulation or transient spike characteristics in such systems have the potential to cause increased power dissipation in the LED driver and also may push the current sources into their linear regions of operations. The latter condition requires that a system must either be designed to give enough headroom in the current sources, such that these events do not push them into their linear region of operation, thus increasing on-chip power dissipation or, alternatively, accepting poor LED current control that will result from many transitions into the linear region.

For example, if the circuit is designed to drive 8 stacks of LEDs, there exist 9 possible load conditions. These load conditions are 0 amps (all stacks off), I_{LED} (one stack conducting), 2XI_{LED} (two stacks conducting), . . . 8XI_{LED} (all 8 stacks conducting). Thus, over the course of operation, a control term specific to each of these load conditions may be provided. The control scheme related to the circuit of FIG. 4 attempts to provide an input to the loop that reduces the amount of voltage shift required to the GM amplifier output node. This allows the integral control to be kept in the loop while eliminating the main component to the transient voltage event.

This may be accomplished by the control algorithm and DAC 408 in a number of ways. In a first embodiment, a simple scheme uses a gain term that amplifies the input to the loop defined by the integrator 402. Given that the integral term is proportional to the inductor current I_{L} (beyond the continuous conduction point), the gain may be varied to attempt to reduce the total range of the output of the integrator, formed from GM amplifier 402, over the range of possible load currents. In an LED driver system which uses PWM controls to dim the LEDs, a differential gain can be applied to each possible load combination (0 to N LED strings conducting), providing a much reduced integrator output swing, and therefore smaller voltage transients. This can be based on calculations of the inductor current at the time of design or simulation based, where a gain is picked via simulations that show the characteristics of the GM integrator output during the various load conditions. In non LED systems where the load is known but has many more states than is practical to implement discretely, the gain term can be continuous with a relationship between load and gain developed to best fit the application. This probably will not give a perfect fit, but so long as the total integrator range is reduced, the transient response is improved.

In an alternative embodiment, a more complex scheme can be used with discrete load steps. The integrator output can be monitored and make use of a digital control scheme to attempt to pull the output value to a known level. For example, the integrator output voltage goes up in response to a higher load current, and the system will add a contribution to the loop via the digital-to-analog controller (DAC) within block 408 to try and bring down the output voltage. Similarly, a contribution is removed from the loop when the output voltage goes down in order to attempt to bring it back up to a desired level. The latest digital-to-analog controller code used can be stored for each possible load level and applied at the start of any condition where the particular load is presented. In this manner, the system can build up and use a stored predetermined set of offset values as inputs to the loop to limit the range of the integrator output and minimize output voltage transients. The advantage of this method over the first alternative is that the effective gain of the integrator term in the loop does not change with load level and proportional control can still be carried out by use of a resistor in series with the compensation capacitor without providing varying proportional gains of the load current.

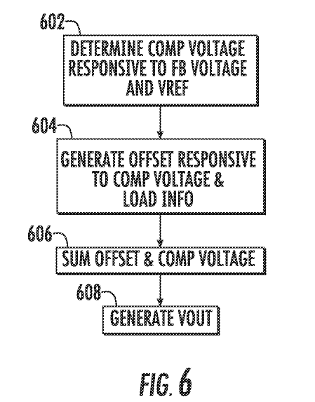

Referring now to FIG. 6, there is illustrated a flow diagram describing the operation of the boost regulator 202 utilizing the described control algorithm. Initially, at step 602 a determination is made of the compensation voltage responsive to the FB voltage and the V_{REF} voltage by the GM amplifier 402. The control algorithm within block 408 determines a control offset value responsive to the provided compensation voltage and the load information as indicated by the number of LED strings 204 conducting. The generated offset control value controls the digital-to-analog converter within the control block 408 to generate the correction offset analog voltage which is added at step 606 to the compensation voltage within the adder circuit 406. The offset compensation voltage is used in generating the output voltage through the summation circuit 416 and latch 418 that generate the switching control signals controlling at step 608 the output voltage V_{OUT} at node 210.

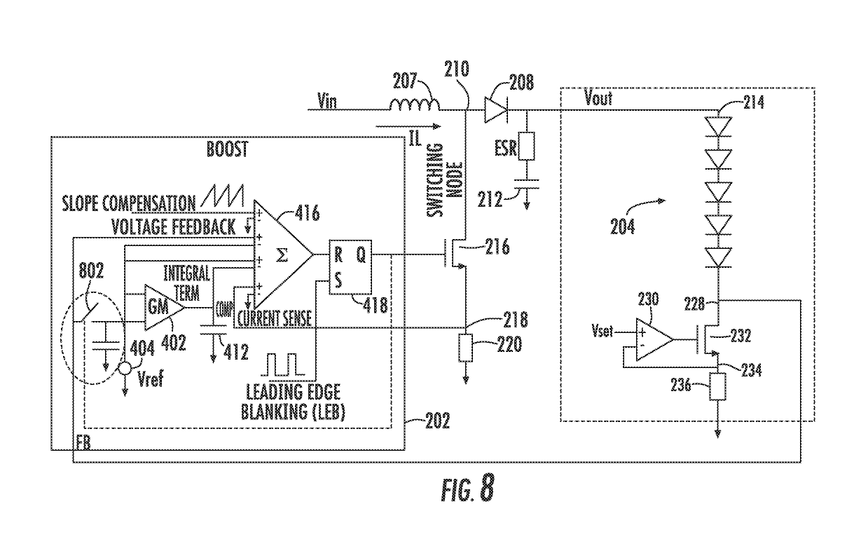

Referring now to FIG. 7, there is illustrated the load current I_{L} 702, the COMP voltage 704 and the output voltage V_{OUT} 706 for a system using the boost transient suppression method described herein above. As described previously, the load current increases at times T₁, T₂ and T₄. Unlike in the wave forms illustrated with respect to FIG. 5, the COMP voltage 704 settles very quickly as the levels are very close to the previous levels due to the added COMP voltage offset. Consequently, within the output voltage signal V_{OUT} 706 only small transient voltage spikes remain which are caused by the time taken to ramp the inductor current to the new level. A similar situation can be seen in cases where the load current is stepped down at times T₃ and T₅. Comparisons between the illustrations in FIGS. 5 and 7 illustrate the significant transient suppression provided by the use of the correction offset with the voltage compensation signal.

Referring now to FIG. 8, there is illustrated the manner in which the boost regulator 202 may be configured to provide ripple rejection. Integral control is included within the DC/DC controller loops via the integrator formed around GM amplifier 402 as described previously to improve absolute accuracy while maintaining a smaller output capacitor than would be required by the same accuracy in equivalent proportional control schemes. The voltage ripple on the DC/DC output is defined by a number of factors including V_{IN}, V_{OUT}, I_{LOW}, I inductor value, output capacitance and output capacitance capacitor effective series resistance. These are related via the following equations:

Duty cycle D=(Vₒᵤₜ−Vᵢₙ)Nₒᵤₜ

Avg inductor current ILavg(average)=Iload*Vout/(Vin*efficiency)

Peak inductor current ILpeak=ILavg+Vᵢₙ/L*D*T*0.5(for continuous system)

Capacitor ripple current Iripple=ILpeak

Capacitor ripple voltage Vripple=ESR*ILpeak

In a given system, where most of these terms are defined, the important figures for defining ripple are the peak inductor current which is defined by the load current and other factors, and the output capacitor ESR. In high voltage applications such as an LED driver where many LEDs are connected in series, the type of capacitors used to obtain the required output capacitances can have a relatively high ESR. This can provide high level output ripple. The operation of the integral control scheme will mean that the average value of this ripple wave form will be regulated to the required level. For most applications this is acceptable. However, LED driver systems attempt to regulate the voltage at the top of an LED string such that the voltage at the bottom is only just enough for the current source to function properly. This is done to minimize power dissipation in the LED driver. If this lower level is regulated to the average of the target level, the lower portions of the ripple are below the target and they push the current source into its linear region of operation. This will get worse as the load current and ESR increase and also if the number of LEDs increases thus increasing the inductor current. To solve this, the target voltage must be raised to guarantee that it does not affect operation. This is difficult to do in practice and will result in the headroom for the current sources being set higher than required to guarantee that there is never a problem, increasing potential power dissipation in cases where it is not needed.

FIG. 8 illustrates a boost converter providing a new method for applying the feedback signal at the FB pin to the input of the GM amplifier 402. The input of the FB pin which is normally fed to both the GM amplifier 402 and the voltage feedback term in the control loop of the summation circuit 416 in the control loop is sampled and held by a switch 802 on the input to the GM amplifier 402. By sampling and holding this voltage when the switching node is at a logical “low” level at the Q output of flip-flop 418, the integrator, formed out of GM amplifier 402, sets the regulation point to the lowest point in the output ripple wave form. This allows the portions in the wave form to align with the reference voltage. This means that the headroom of the current source can be set to a much lower level while guaranteeing that ripple will not be able to push the current sources into their linear regions of operation.

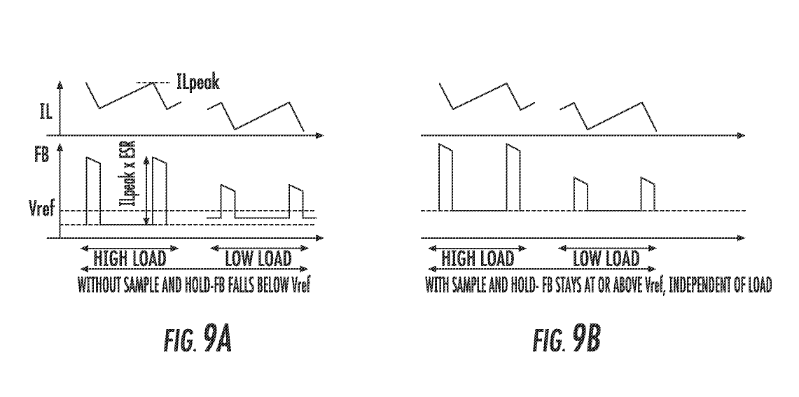

Referring now to FIGS. 9a and 9b, there are illustrated the inductor current I_{L} and reference voltage feedback (FB) waveforms with respect to a circuit not using the sample and hold switch (FIG. 9a) and a circuit using the sample and hold switch (FIG. 9b). When the sample and hold circuit is not used, the feedback voltage falls below the reference voltage V_{REF} at a number of points during operation. FIG. 9b illustrates the use of a sample and hold circuit and the feedback voltage FB remains above the reference voltage V_{REF} at all times independent of the provided load current I_{L}.

The boost regulator produces the minimal voltage needed to enable the LED string 204 with the highest forward voltage drop to run at the programmed current. The circuit employs a current mode control boost architecture that has a fast current sense loop and a slow voltage feedback loop. This architecture achieves a fast transient response that is essential for notebook backlit applications where the power can be a serious drain on batteries or instantly charged to an AC/DC adaptor without rendering noticeable visual nuisance. The number of LEDs that can be driven by the circuit depends on the type of LED chosen by the application.

The circuit is capable of boosting up to 34.5 volts and driving 9 LEDs in series for each channel. However, other voltage boost levels and numbers of LEDs may be supported in alternative embodiments. The dynamic headroom control circuit controls the highest forward voltage LED stack or effectively the lowest voltage from any of the input current pins. The input current pin at the lowest voltage is used as a feedback signal for the boost regulator. The boost regulator drives the output to the correct levels such that the input current pin at the lowest voltage is at the target headroom voltage. Since all of these LED strings are connected to the same output voltage, the other input current pins will have a higher voltage, but the regulated current source on each channel will ensure that each channel has the same programmed current. The output voltage will regulate cycle by cycle and is always referenced to the highest forward voltage string in the architecture.

A common problem within switching converters that include integral control terms is that the output voltage level V_{OUT} of the switching converter will overshoot at start up and when high load levels step to a lower level. This can create a variety of problems within the voltage regulator including providing an over voltage condition to the circuit being supplied by the converter. Thus, there is a need to provide some manner for picking up this overshoot voltage at an early stage and dramatically limiting its size by halting switching within the switching converter. Additionally, there is a need to enable the output voltage from a switching converter used with an LED driver to be held at the voltage level necessary for a start condition even when the LED off times are long during which the output capacitor associated with the switching converter would normally start to discharge due to self-discharge in the OVP (Over Voltage Protection) resistors across the capacitor. The switching converter implemented within, for example, the circuit of FIG. 2, may switch at low current levels to maintain the output voltage at desired levels even when the LEDs are turned off By allowing the switching converter to switch during these LED off times, the voltage is kept at the correct level for accurate current to be maintained within the converter as well as enabling extremely short LED on times to be possible even if the on times are significantly shorter than the switching converter response times. The implementation described herein below utilizes part of the control loop to enable the correct amount of voltage to be maintained in a PI control loop, when the integral terms have been frozen to maintain the value for one LED on time to the next. Additionally, the control loop may be used to eliminate the large overshoots in DC/DC switching converters. This is often a problem in loops having an integral term, particularly at start up. By using the techniques described herein below, the overshoot can be minimized without worries of offsets between different circuit blocks.

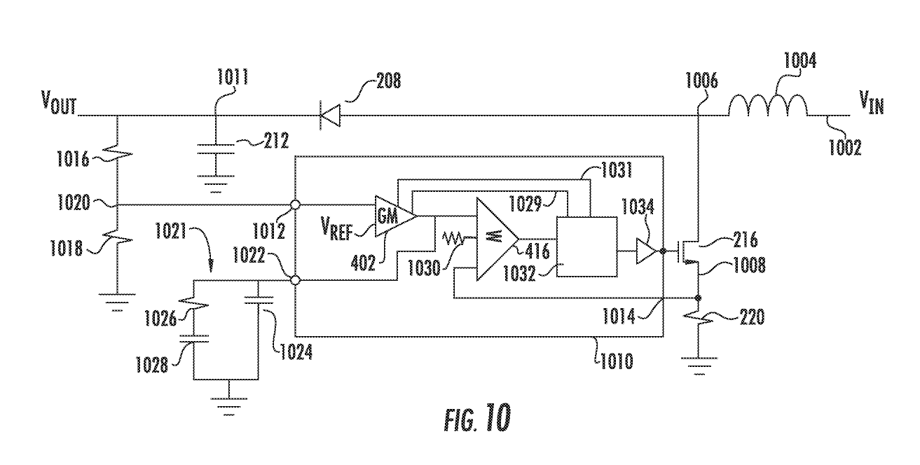

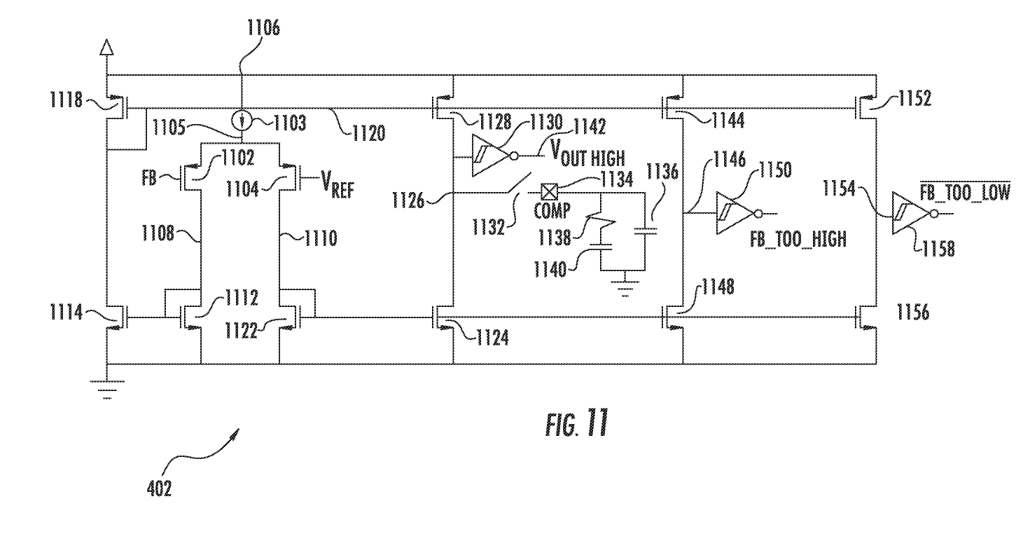

Referring now to FIG. 10, there is provided a simplified block diagram of a boost regulator circuit for driving an LED string as described with respect to FIG. 2. The input voltage V_{IN} is applied at node 1002. An inductor 1004 is connected between node 1002 and node 1006. A switching transistor 216 is connected between node 1006 and node 1008. The gate of transistor 216 is connected to receive PWM control signals from a boost controller 1010. The switching transistor 216 comprises an N-channel transistor having its drain/source path connected between node 1006 and node 1008. A resistor 220 is connected between node 1008 and ground for current sensing. However other methods may be used for current sensing.

The boost regulator also includes a diode 208 having its anode connected to node 1006 and its cathode connected to the output voltage node 1011. The output voltage node 1011 provides the output voltage V_{OUT} which is applied to the LED strings discussed previously. A capacitor 212 is connected between node 1011 and ground. The boost controller 1010 controls operation of the switching transistor 216 responsive to a feedback voltage provided at feedback pin 1012 and a current to the switching transistor sensed at node 1008 via pin 1014. The feedback pin 1012 is connected to a resistor divider network consisting of resistors 1016 and 1018. Resistor 1016 is connected between node 1011 and node 1020 which is connected to the FB pin 1012 and resistor 1018 is connected between node 1020 and ground.

The boost controller 1010 includes an integrator consisting of a GM amplifier 402 and capacitor 1026 has one input connected to the feedback voltage pin 1012 and the other input connected to a reference voltage V_{REF}. The integrator provides an output that is connected to one input of the summation circuit 416. The GM amplifier 402 may be used for eliminating large voltage overshoots at the output node 1010 and for holding the output voltage at a correct level even during extended LED off times. The output of the GM amplifier 402 is also connected to COMP pin 1022 to which a loop filter network is connected. The loop filter circuitry 1021 consists of a combination of a capacitor 1024 connected between node 1022 and ground and a series connection of a resistor 1026 and a capacitor 1028 that is connected in parallel with capacitor 1024 between pin 1022 and ground. Other loop filter configurations are also possible. The GM amplifier 402 also provides a control signal V_{OUTHIGH} and FB_TOO_HIGH via control lines 1029 and 1031, respectively.

The summation circuit 416 receives the output from the integrator formed around GM amplifier 402, a ramp signal 1030 and the sensed current at node 1008 to generate a control output to switching control logic 1032. The switching control logic 1032 provides control signals to the switch driver 1034 for generating the PWM control signals to the switching transistor 216.

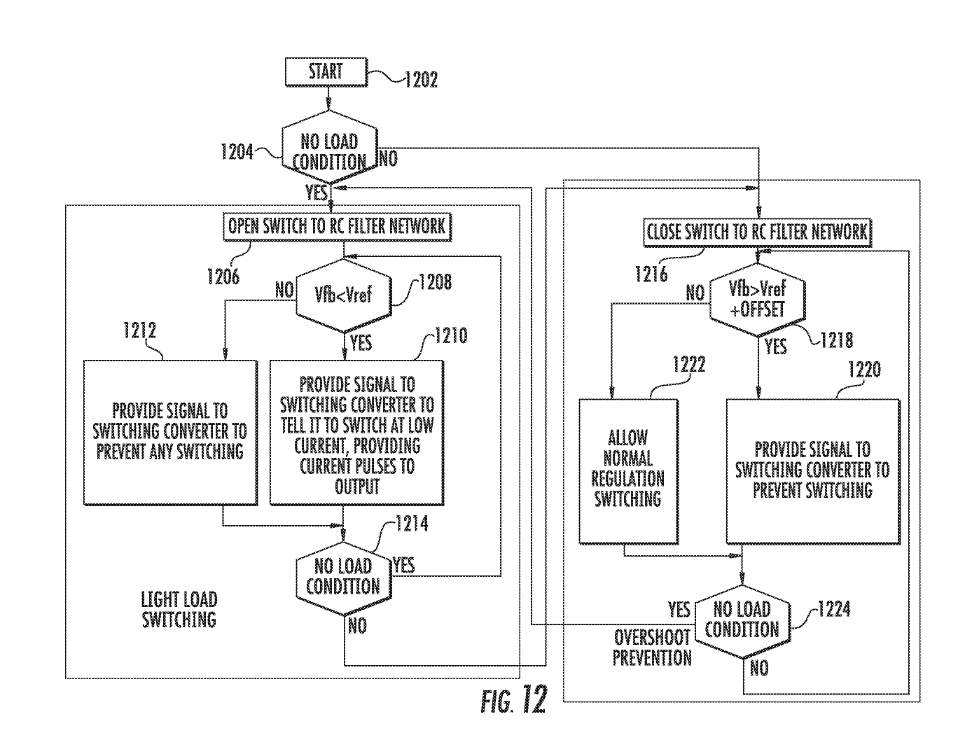

Referring now to FIG. 11, there is provided a schematic diagram of the GM amplifier 402. The feedback voltage and reference voltage V_{REF} are applied at the input stage consisting of transistors 1102 and 1104. Transistor 1102 is a P-channel transistor having its source/drain path connected between a current source 1103 and node 1108. The current source 1103 is connected between V_{DD} and node 1105. The gate of transistor 1102 is connected to receive the feedback voltage from pin 1012. Transistor 1104 comprises a P-channel transistor having its source/drain path connected between the current source 1103 and node 1110. Transistor 1112 is an N-channel transistor having its drain/source path connected between node 1108 and ground. The gate of transistor 1112 is also connected to node 1108. The gate of transistor 1112 is also connected to the gate of transistor 1114. Transistor 1114 comprises an N-channel transistor having its drain/source path connected between node 1120 and ground. A P-channel transistor 1118 has its source/drain path connected between node V_{DD} 1106 and node 1120. The gate of transistor 1118 is connected to node 1120.

Transistor 1122 comprises an N-channel transistor having its drain/source path connected between node 1110 and ground. The gate of transistor 1122 is also connected to node 1110 and to the gate of another transistor 1124. Transistor 1124 comprises an N-channel transistor having its drain/source path connected between node 1126 and ground. A P-channel transistor 1128 has its source/drain path connected between node V_{DD} 1106 and node 1126. The gate of transistor 1128 is connected to node 1120. A Schmitt trigger 1030 has its input connected to node 1026 and provides the output signal V_{OUTHIGH} that is provided as the output of the GM amplifier 402.

The circuitry for use with the light load mode is implemented at node 1126. The Schmitt trigger 1130 is only used to determine when to switch in that the light load mode. A switch 1132 is connected between node 1126 and the COMP pin 1134. The compensation network includes a capacitor 1136 connected between pin 1134 and ground. Connected in parallel with the capacitor 1136 between pin 1134 and ground is a series connection of resistor 1138 and capacitor 1140. The switch 1132 is opened and closed based upon whether a load connected to the output node 1011 of the switching converter is zero. In normal mode, when a load is present, switch 1132 is closed and the compensation network is attached providing an integrator in the system. Pin 1134 comprises an analog output and is provided to the summation circuit 416. The output from node 1142 is ignored in this mode. When the load is zero, the switch 1132 is opened and disconnects the compensation network from the GM amplifier 402. This removes the integrator from the system. The output from node 1142 is used in the no load condition to give a digital switch/don't switch indication. In this mode, the output of summation circuit (a multi-input comparator) 416 is ignored as its output is invalid. The switch 1132 enables the operation of the light switching mode of operation when no load is present. This guarantees that the same regulation point is maintained, as the GM amplifier input offset is the same for both modes of operation.

In systems such as LED drivers where the load on the switching converter/switching regulator is known and can step to zero at various times during its operation, the switching converter is often turned off during “zero load” periods. The value on the GM amplifier output is typically held at a selected level to enable the system to snap quickly back to its previous regulation point when the load resumes. However, while the intended load is zero, there is usually a residual load provided by the feedback/OVP (over voltage protection) resistors connected to the output circuit, as well as self capacitor discharge. Some LED systems rely on keeping this output voltage poised at a correct level to resume conduction even during zero load periods in order to enable high accuracy, very short pulse currents to be generated from the correct voltage. This must typically be done using a large output capacitor to maintain the charge during these times (the “off” periods of the LED PWM switching times) from the previous time. If this was not done the current pulse can initially be compressed. Additionally, when fast pulses are used, the pulses can be finished before the switching current has had a chance to regulate back to the correct level. Additional problems arise if the current pulses are short enough, there is not enough time during these pulses for the converter to switch on, meaning that the converter spends its entire time not switching and cannot deliver the load current required even though the average load is very small.

The GM amplifier 402 maintains the output voltage level of the converter by enabling the DC switching converter to switch at low current levels during these zero load times. In systems where the GM amplifier output is sampled and held when the load is zero, the normal proportional control term feeding the switching loop is not present during these times making it impractical for the loop to regulate in a normal manner. Thus, a solution is needed for some other type of switching which still regulates the same target point including errors from the offsets normally in the closed loop. The GM amplifier described with respect to FIG. 11, accomplishes this by using the disconnected GM amplifier output as a go/no-go indication for switching.

When the load is zero, a control signal LED OFF causes switch 1132 to open and disconnects the compensation network connected at COMP pin 1134 from transistors 1124 and 1128. This causes node 1126 (the GM amplifier output node) to have a very low time constant, and swing high or low dependant on whether the output voltage is above or below the target. This provides an indication of whether the feedback signal is below or above the reference voltage V_{REF} in a digital fashion. This operates as a comparator. This information can be used to initiate a short pulse in the inductor 1004, and keep doing so as long as the feedback voltage (1012) is below the reference voltage V_{REF}. This causes the switching converter to switch and increase the output voltage. In this manner, the output level can be maintained indefinitely even when the load is zero.

Additionally, when the load is made up of very short pulses of current, and the switching converter cannot switch normally within the short pulse times, the current can instead be provided by the switching method during the zero load times. This means that not only can the voltage be maintained when not loaded, but when the pulses are long enough to allow the switching converter to switch, the converter can snap on and off to a very accurate level, with the minimal of V_{OUT} transients, as the integrator output value (used during loaded conditions) is held in between, maintaining the information needed to control the loop regulation point during conduction. This implementation enables any offsets in the GM amplifier 402, which causes an error in the normal regulation point, to provide exactly the same error in a regulation point during the zero load mode of operation. This means that the voltage maintained at zero load should be as close as possible to the normal level.

The converter is switched responsive to an output from the GM amplifier 402 when the output voltage falls below the reference voltage V_{REF}. A low current limit is used in the switch 216 such that the cycle terminates as soon as the current in the inductor reaches a fixed low level. This provides small fixed size current pulses into the load, which complete in less than one switching cycle, providing just enough energy to keep the output voltage at the required level. Should a single pulse not be sufficient, several pulses will occur consecutively to cause the output to reach the correct level. This can also be done by switching in a fixed duty cycle in this condition although it would be less well controlled. This solution is only applicable to designs that regulate V_{OUT} correctly by monitoring V_{OUT} continuously through, for example, a resistor stack. Some LED drivers take their feedback voltage from the bottom of the LED stack something that would not be possible here as these cases all output level information is lost when the LEDs are off.

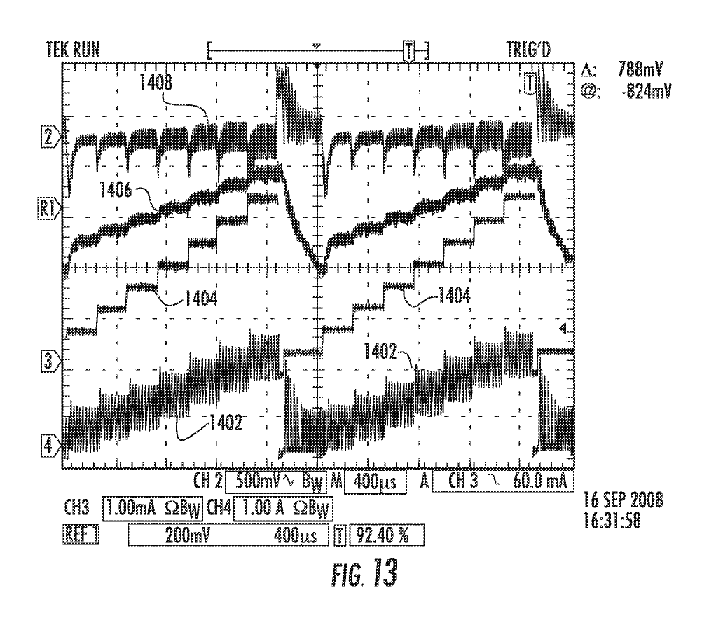

Referring now to FIG. 12, there is illustrated a flow diagram describing the operation of the GM amplifier for enabling the output voltage to be held at a correct level for start conditions. The process is initiated at step 1202 and inquiry step 1204 determines whether the converter is in a no load condition. If inquiry step 1204 determines that a no load condition exists, the switch 1132 to the RC filter network is opened at step 1206. Inquiry step 1208 determines whether the feedback voltage V_{FB} is less than a reference voltage V_{REF}. If so, a signal is provided to the switching converter to control the converter to switch at a low current level thus providing a current pulse to the output of the converter at step 1210. If the feedback voltage is not less than the reference voltage, a signal is provided to the switching converter to prevent any switching from occurring at step 1210. After the signals are provided in accordance with either steps 1212 or step 1210, inquiry step 1214 determines whether a no load condition still exists. If so, control passes back to step 1208. If inquiry step 1214 or inquiry step 1204 determines that a no-load condition does not exist, control passes to the progress for the prevention of overshoot as will be discussed more fully herein in a moment.

Referring now back to FIG. 11, a P-channel transistor 1144 has its source/drain path connected between node V_{DD} 1106 and node 1146. The gate of transistor 1144 is connected to node 1120. A transistor 1148 comprises an N-channel transistor having its drain/source path connected between node 1146 and ground. The gate of transistor 1148 is connected to the gate of transistor 1122 at node 1110. A Schmitt trigger 1150 has its input connected to node 1146, the output of the Schmitt trigger 1150 provides an output when an over voltage condition occurs at node 1011 (FIG. 10) of the voltage converter. The output of Schmitt trigger 1150 prevents any switching of the converter when its output is high for more than a whole switching cycle.

Transistor 1152 comprises a P-channel transistor having its source/drain path connected between node vdd and node 1154. The gate of transistor 1152 is connected to the gates of transistors 1144, 1128 and 1118. An N-channel transistor 1156 has its drain/source path connected between node 1154 and ground. The gate of transistor 1156 is connected with the gates of transistors 1148, 1124 and 1122 at node 1110. A Schmitt trigger 1158 has its input connected to node 1154 and its output provides a signal indicating when the feedback voltage is too low at node 1011 of the voltage converter. The Schmitt trigger 1158 generates an under voltage indication indicating the regulated output voltage has fallen below a second predetermined level and activates the voltage regulator in response thereto.

The circuitry of the GM amplifier 402, as illustrated in FIG. 11, provides a manner for detecting when overshoot is occurring at the output voltage node 1011 and provides the ability to stop the switching converter from switching until the output voltage V_{OUT} at node 1011 has subsided to an acceptable level. The problem with detecting the overshoot of V_{OUT} is that there is typically a very small voltage difference. For example, if the switching converter is a boost circuit as illustrated in FIG. 10, and is boosting the input signal V_{IN} up to 40 volts while using a 1.2 volt V_{REF} value applied to the GM amplifier 402, a 500 millivolt overshoot is only about a 15 millivolt signal (0.5V×1.2V/40V) at the feedback node 1112. In theory, a comparator could be used between a reference voltage 15 millivolts above the V_{REF} level and the FB node 1112, but the offset of this comparator and the offset of the GM amplifier would have to be small enough such that the comparator threshold and the FB regulation level do not cross. This means setting the thresholds a reasonable distance apart and accepting a great deal of variation in the detection threshold when compared to the regulation point. Thus it is difficult to reliably detect this condition when it comprises a predictably small amount while at the same time guaranteeing that it does not prevent the circuit from switching when the level is correct or under heavy loading in a noisy system.

The GM amplifier 402 illustrated in FIG. 11 is designed to pick up this condition. Typically, integrators have offsets that are dominated by the input stage consisting of transistors 1102 and 1104. The implementation of FIG. 11 adds the secondary output stages consisting of transistors 1048, 1044, 1156 and 1152 along with inverters 1150 and 1158. These secondary output stages are designed to skew the output current so that they provide an intended offset. In FIG. 11, transistors 1156 and 1044 are sized to conduct (1+N) times as much current as transistors 1024, 1148, 1128 and 1152. When the integration formed around the GM amplifier is set to the regulation point of the switching loop through feedback, and the loop is stable, the current flowing through transistors 1124 and 1128 should be the same over the course of each switching cycle. Thus, the current in transistor 1144 will be greater than the current in transistor 1148 by a factor of (1+N), and node 1046 will be at a logical “high” level. By scaling with the gain of the input stage consisting of transistors 1102 and 1104, or the factor N, it is possible to reliably set a difference in the input voltage level (V_{FB}−V_{REF}) from the normal regulation point where the current in transistor 1144 will no longer exceed the current in transistor 1148 and the voltage at node 1146 will go to a logical “low” level. The same thing can be done in reverse to detect when the feedback voltage is more than a certain amount below the target level using transistors 1156, 1152, and the voltage at node 1154. Thus, the output of Schmitt trigger 1158 provides an indication of when the feedback voltage is more than a certain amount below the target level and the output of Schmitt trigger 1150 provides an indication of when the feedback voltage is more than a certain amount above the target level.

This solution eliminates the need to know the offset of the GM amplifier 402. The offset is dominated by the input stage consisting of transistors 1102 and 1104 which is shared by all three input stages, and enables detection of a predictable window around the regulation point whatever the offset may be. This implementation can be used for a number of functions including voltage overshoot protection. So long as the output of the GM amplifier 402 is filtered, so as to guarantee that it will provide a constant indication that the feedback level is higher than the target value V_{REF} for more than a fixed period of time (for example, at least one switching cycle), the filtered output can be used to stop the converter from switching. This allows the overshoot to be detected early and prevented from continuing. By filtering the signal in this way, the thresholds can be very close to the regulation level (approximately 6 millivolts has been used in one design) making voltage overshoot quite small. It is also advisable to use some hysteresis on the threshold to force the overshoot that has already occurred to recover slightly before allowing it to start switching again, here shown by the use of the Schmitt triggers 1150 and 1158, although other implementations are possible.

An overvoltage protection substitute function in an LED driver or similar application may also be provided. Any application that has a boost loop with a variable reference voltage input to the loop can use the above overshoot protection to prevent a true OVP event from occurring, but stopping switching if Vout goes more than a fixed amount above the target. Additionally, systems that must report when their output voltage is within a certain range of the target value may use this system either to provide a “start up complete” signal, an indication of heavy load/transients, or fault conditions, that can use both the outputs to say if it is below or above the target reference voltage.

Referring now back to FIG. 12, if either of steps 1204 or 1214 determine that a no-load condition does not exist, control passes to step 1216 and the switch 1132 to the RC network is closed. Inquiry step 1218 determines whether the feedback voltage V_{FB} is greater than the reference voltage V_{REF} plus an offset. If so, a signal is provided at step 1220 to the switching converter to prevent switching. If the feedback voltage is not greater than the reference voltage plus the offset, normal regulation switching of the switching converter is allowed at step 1222. Next, inquiry step 1224 determines whether a no-load condition exists and if not, control passes back to inquiry step 1218. If inquiry step 1224 determines that a no load condition exists, control passes to step 1206 to open the switch of the RC filter network.

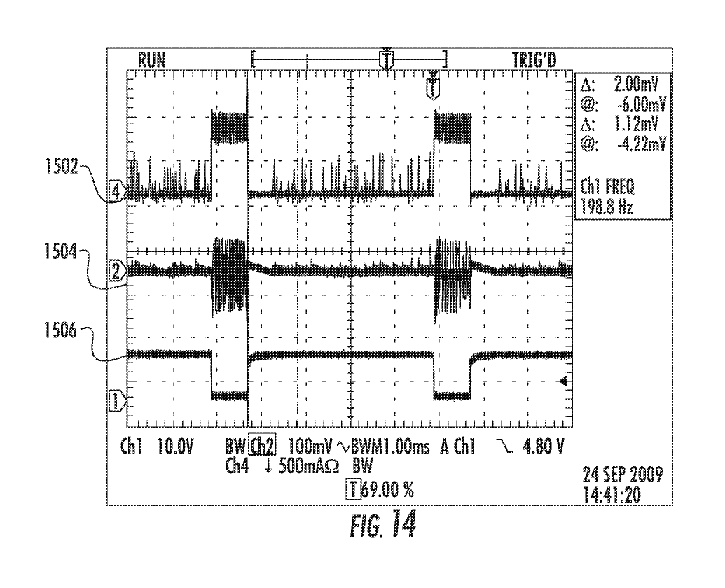

Referring now to FIG. 13, there are illustrated various wave forms associated with the operation of the circuit of FIGS. 10 and 11. The wave form 1402 comprises the inductor current. The wave form 1404 comprises the load current. The wave form 1406 comprises the GM amplifier output and the wave form 1408 comprises the output voltage V_{OUT}. It can be seen that the output voltage tries to overshoot when the load steps down from approximately 320 milliamps to 40 milliamps. The output voltage continues trying to do this until the COMP signal drops to the appropriate voltage. In the interim, the boost regulator keeps overshooting slightly, the inductor current being interrupted and restarted.

Referring now to FIG. 14, there are illustrated various waveforms associated with the operation of the circuit of FIGS. 10 and 11. The wave form 1502 comprises the inductor current. The wave form 1504 comprises the output voltage V_{OUT}. The wave form 1506 comprises the voltage at the bottom cathode of the LED stack (which goes low when the LEDs are conducting). It can also be seen that when the LEDs are conducting, the output voltage level 1504 has some ripple and when they switch off there is a little overshoot due to residual change in the inductor. However, two interesting points to note are that after the LEDs switch off, the output voltage 1504 decays and flattens out at a particular point as it is topped up with low current switching once it decays to the regulation point and secondly, when the LEDs enable again, there is minimal offset and the boost recovers fairly quickly with only minor undershoot. Thus, using the presently described circuitry of FIGS. 10 and. 11, the overshoot may be drastically reduced in switching converter systems with an integral control term. Additionally, the output regulation of the switching circuit during the LED off times is improved so that the system is poised at the right point when the LEDs are switched back on.

It will be appreciated by those skilled in the art having the benefit of this disclosure that this GM amplifier or a similar implementation can be used to providing overshoot protection and light switching mode during zero load conditions for an LED driver circuit. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A voltage regulator system, comprising:
voltage regulation circuitry for generating a regulated output voltage responsive to an input voltage and switching control signals;
a voltage divider connected to an output node of the circuitry for providing a monitored output voltage;
a voltage regulator controller generating the switching control signals responsive to the monitored output voltage and a reference voltage; and
a compensation network associated with the voltage regulator controller;
wherein the voltage regulator controller further controls the circuitry for regulating output pulses to maintain a regulated output voltage responsive to an indication that the monitored output voltage is below a reference voltage in the no-load condition without interaction with a compensation network and further wherein the voltage regulator controller selectively associates the compensation network with the voltage regulator controller responsive to a load condition and selectively disconnects the compensation network from the voltage regulator controller responsive to a no-load condition.

2. The voltage regulator system of claim 1, wherein the voltage regulator controller further generates an over shoot indication indicating the regulated output voltage has exceeded a first predetermined level and disables the circuitry for generating in response thereto.

3. The voltage regulator system of claim 2, wherein the voltage regulator controller further generates an under voltage indication indicating the regulated output voltage has fallen below a second predetermined level and activates the circuitry for generating in response thereto.

4. The voltage regulator system of claim 1, wherein the controller further includes a GM amplifier for generating a control voltage responsive to the monitored output voltage and the reference voltage and for generating an indication to create the output pulse.

5. The voltage regulator system of claim 1, wherein the GM amplifier further comprises:
an input stage for receiving the monitored output voltage and the reference voltage;
first circuitry for generating an indication as the feedback voltage when the monitored output voltage exceeds the reference voltage;
wherein the first circuitry provides the indication to indicate whether the monitored output voltage is above or below the reference voltage in the no-load condition without feedback from the compensation network.

6. The voltage regulator system of claim 5, further including:
second circuitry for generating a second indication when the monitored output voltage exceeds a first predetermined level; and
wherein the first predetermined level corresponds to an overshoot level of the monitored output voltage.

7. The voltage regulator system of claim 6, wherein the second circuitry further generates a third indication when the monitored output voltage falls below a second predetermined level, wherein the second predetermined level corresponds to an undershoot level of the monitored output voltage.

8. The voltage regulator system of claim 6, wherein the second circuitry further includes transistors sized to define the first predetermined level and the second predetermined level.

9. The voltage regulator system of claim 4 further including switching circuitry for selectively associating a compensation network with an output node of the GM amplifier responsive to a load condition and for selectively disconnecting the compensation network from the output node of the GM amplifier responsive to a no-load condition.

10. A voltage regulator system, comprising:
circuitry for generating a regulated output voltage responsive to an input voltage and switching control signals;
a voltage divider connected to an output node of the circuitry for providing a monitored output voltage;
a voltage regulator controller generating the switching control signals responsive to the monitored output voltage and a reference voltage;
a compensation network associated with the voltage regulator controller;
wherein the voltage regulator controller further generates an over shoot indication indicating the regulated output voltage has exceeded a first predetermined level and disables the circuitry for generating in response thereto and further wherein the voltage regulator controller selectively associates the compensation network with the voltage regulator controller responsive to a load condition and selectively disconnects the compensation network from the voltage regulator controller responsive to a no-load condition.

11. The voltage regulator system of claim 10, wherein the voltage regulator controller further generates an under voltage indication indicating the regulated output voltage has fallen below a second predetermined level and activates the circuitry for generating in response thereto.

12. The voltage regulator system of claim 10, wherein the controller further includes a GM amplifier for generating a control voltage responsive to the monitored output voltage and the reference voltage and for generating the overshoot indication.

13. The voltage regulator system of claim 12, wherein the GM amplifier further comprises:
an input stage for receiving the monitored output voltage and the reference voltage;
first circuitry for generating an indication as the feedback voltage when the monitored output voltage exceeds the reference voltage;
second circuitry for generating a second indication when the monitored output voltage exceeds a first predetermined level; and
wherein the first predetermined level corresponds to an overshoot level of the monitored output voltage.

14. The voltage regulator system of claim 13, wherein the second circuitry further generates a third indication when the monitored output voltage falls below a second predetermined level, wherein the second predetermined level corresponds to an undershoot level of the monitored output voltage.

15. The voltage regulator system of claim 13, wherein the second circuitry further includes transistors sized to define the first predetermined level and the second predetermined level.

16. The voltage regulator system of claim 12 further including switching circuitry for selectively associating a compensation network with an output node of the GM amplifier responsive to a load condition and for selectively disconnecting the compensation network from the output node of the GM amplifier responsive to a no-load condition.

17. The voltage regulator system of claim 16, wherein the first circuitry provides the indication to indicate whether the monitored output voltage is above or below the reference voltage in the no-load condition without interaction with the compensation network

18. A method for providing a feedback voltage for a voltage regulator controller, comprising:
receiving a monitored output voltage and a reference voltage;
generating an indication as the feedback voltage when the monitored output voltage exceeds the reference voltage;
generating a second indication when the monitored output voltage exceeds an overshoot level of the monitored output voltage;
disabling switching circuitry of a voltage regulator responsive to the second indications;
selectively associating a compensation network with an output node of an GM amplifier responsive to a load condition; and
selectively disconnecting the compensation network from the output node of the GM amplifier responsive to a no-load condition.

19. The method of claim 18, further including the step of generating a third indication when the monitored output voltage falls below an undershoot level of the monitored output voltage;
and actuating the switching circuitry of the voltage regulator responsive to the third indication.

20. The method of claim 18, wherein the step of generating the indication further comprises the step of providing the indication to indicate whether the monitored output voltage is above or below the reference voltage in the no-load condition to control the operation of the voltage regulator controller.
